(19) United States
(12) Patent Application Publication
(10) Pub. No.: US 2002/0075307 A1
(43) Pub. Date: Jun. 20, 2002

(54) System and method for dynamic interaction with remote devices

(75) Inventors: Bruce Alexander, Poulsbo, WA (US); Liem Bahneman, Bothell, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Vigilos, Inc.

(21) Appl. No.: 09/966,814

(22) Filed: Sep. 28, 2001

Related U.S. Application Data
(60) Provisional application No. 60/236,282, filed on Sep. 28, 2000.
(60) Provisional application No. 60/281,263, filed on Apr. 3, 2001.
(60) Provisional application No. 60/281,254, filed on Apr. 3, 2001.

(51) Int. Cl. G09G 5/00

(52) U.S. Cl. 345/760

(57) ABSTRACT

A graphical user interface is used for the dynamic management of remote devices. In a Web-based computing environment, browsers are used to remotely access data from devices attached to computer systems. Through the graphical interface displayed on a monitor, the user interacts dynamically with the remote device. That is, the actions of the user within the means of the graphical user interface effect actions, changes, and updates in the remote hardware as if it were a local resource.

### CROSS-REFERENCES TO RELATED APPLICATIONS

This application claims the benefit of U.S. Provisional Application No. 60/236,282, filed Sep. 28, 2000; U.S. Provisional Application No. 60/281,263, filed Apr. 3, 2001, and U.S. Provisional Application No. 60/281,254, filed Apr. 3, 2001, which are hereby incorporated by reference.

### FIELD OF THE INVENTION

In general, the present invention relates to computer software and hardware, and in particular, to a system and method for generating graphical user interfaces for the collection of data from hardware devices.

### BACKGROUND OF THE INVENTION

The development of user interfaces has increased the ease with which users are able to interact with computers. Specifically, a graphical user interface provides a visual environment in which a user manipulates graphical images, such as icons, to accomplish a variety of tasks. In a typical environment, a user activates an application by selecting an icon corresponding to the application by a keystroke or combination of keystrokes on a computer keyboard or with a user interface device, such as a mouse.

Graphical user interfaces are used at the application layer of the Organization for Standardization Open Systems Interconnection “ISO/OSI” reference model to activate a range of computer processes. The ISO/OSI model standardizes the interaction between elements within a communications network. The highest level manages the program-to-program transfer of information and is known as the application level. The lowest level is known as the physical level, and manages hardware connections. The intermediate levels manage the coding, addressing, routing, handling, and transport of messages, the coordination of communication and the formatting and display of data.

Layered architectures, exemplified by the ISO/OSI reference model, divide network communications into discrete layers. Each layer within the system relies upon a set of rules or standards known as protocols that allow clients and servers (requesters and senders) to exchange information within a communications network. With regard to the Internet, TCP/IP corresponds to the transport layer of the ISO/OSI model and is used to control the exchange of data among networks. TCP/IP governs the breakup of data into packets, the routing and delivery of data packets, and the reassembly and verification of data upon delivery.

World Wide Web “WWW” browsers are also capable of downloading and transferring files in a TCP/IP communications network. Browsers transfer and retrieve HTML files and provide access to documents on a network, intranet, or the local hard drive. Browsers are also used to execute programs embedded within HTML documents, known as “applets.” Applets are machine executable instructions contained within other applications and not visible to the user. The diverse communication and internetwork capabilities of browsers are used by the present invention for the purpose of accomplishing dynamic graphical user interaction with remote devices.

In order to access the data and control the operation of the monitoring devices, software that generates the graphical user interface must be loaded onto the client computer. However, software loaded directly onto the client computer has several inherent disadvantages. Specifically, software loaded on the client computer must contain all of the program modules that interact with and control the corresponding monitoring devices. Problems arise when changes are made to the software code such as a correction or, “bug fix” or the inclusion of a new program modules, require loading of an updated version of the software onto the client computer in order to maintain network compatibility. Furthermore, in such a computing environment, data from monitoring device is not accessible to multiple, geographically remote users.

Therefore, there is a need for a system that generates graphical user interfaces to facilitate the collection and management of data within a monitoring network that overcomes the deficiencies of present methods.

### SUMMARY OF THE INVENTION

In accordance with aspects of the present invention, a method for interacting with a remote device is provided. A premises server obtains a request corresponding to controlling one or more identifiable remote devices. The premises server generates a graphical user interface operable to control the remote device, wherein controlling the device includes accessing the remote device and issuing instructions. The premises server obtains user control instructions from the graphical user interface. The premises transmits remote device control data corresponding to the user control instructions, and obtains remote device data generated by the remote device.

In accordance with another aspect of the present invention, a system for dynamically generating a user interface for controlling at least one remote device is provided. The system includes at least one remote device operable to receive control commands and to transmit monitoring data based on the control commands. The system also includes a server computer in communication with the remote device. The server computer is operable to dynamically generate a graphical user interface based on the remote device. The system further includes a client computer in communication with the premises server. The client computer is operable to display the graphical user interface, and request the control commands.

In accordance with yet another aspect of the present invention, a computer-readable medium having computer-executable components for dynamically interacting between at least one remote device and a computing device is provided. The computer-readable medium includes a user interface application operable to dynamically generate a graphical user interface corresponding to the remote device. The computer-readable medium also includes a device interface application operable to communicate device data from the remote device, and operable to manipulate the data. The computer-readable medium further includes a data transmittal application operable to transmit the data to the computing device, and to facilitate communication between the remote device and the computing device.

In accordance with still yet another aspect of the present invention, a method for dynamically generating a user interface for controlling at least one remote device is provided. A premises server obtains a request to control at least one pre-selected remote device. The premises server selects a program module corresponding to the pre-selected remote device from a plurality of program modules. The program module is operable to control the remote device. The premises server transmits a screen interface with the program module, wherein the screen interface containing the program module is operable to generate a graphical user interface when loaded within a browser application.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an Internet environment;

FIG. 2 is a block diagram of a system for dynamic interaction with a remote device in accordance with the present invention;

FIG. 3 is a block diagram depicting an illustrative architecture for a premises server in accordance with the present invention;

FIG. 4 is a block diagram depicting an illustrative architecture for a client computer in accordance with the present invention;

FIG. 5 is a block diagram depicting an illustrative architecture for a central server computer in accordance with the present invention;

FIG. 6 is a flow diagram depicting a control generating process routine in accordance with aspects of the present invention;

FIG. 7 is a flow diagram illustrative of a data processing subroutine in accordance with the present invention;

FIG. 8 is a flow diagram depicting a device manipulating process routine in accordance with aspects of the present invention;

FIG. 9 is a flow diagram illustrative of a monitoring device data processing routine in accordance with aspects of the present invention;

FIG. 10 is a flow diagram illustrative of a device event processing subroutine in accordance with aspects of the present invention;

FIGS. 11A and 11B are flow diagrams illustrating an asset/resource event processing subroutine in accordance with aspects of the present invention;

FIG. 12 is illustrative of a screen display produced by a WWW browser depicting a graphical user interface for enabling a user to view monitoring device data in accordance with the present invention;

FIG. 13 is illustrative of a screen display produced by a WWW browser depicting a graphical user interface for enabling a user to view and manipulate monitoring device data in accordance with the present invention; and

FIG. 14 is an exemplary graphical user interface illustrating a dual feed viewer interface in accordance with the present invention.

### DETAILED DESCRIPTION OF THE PREFERRED EMBODIMENT

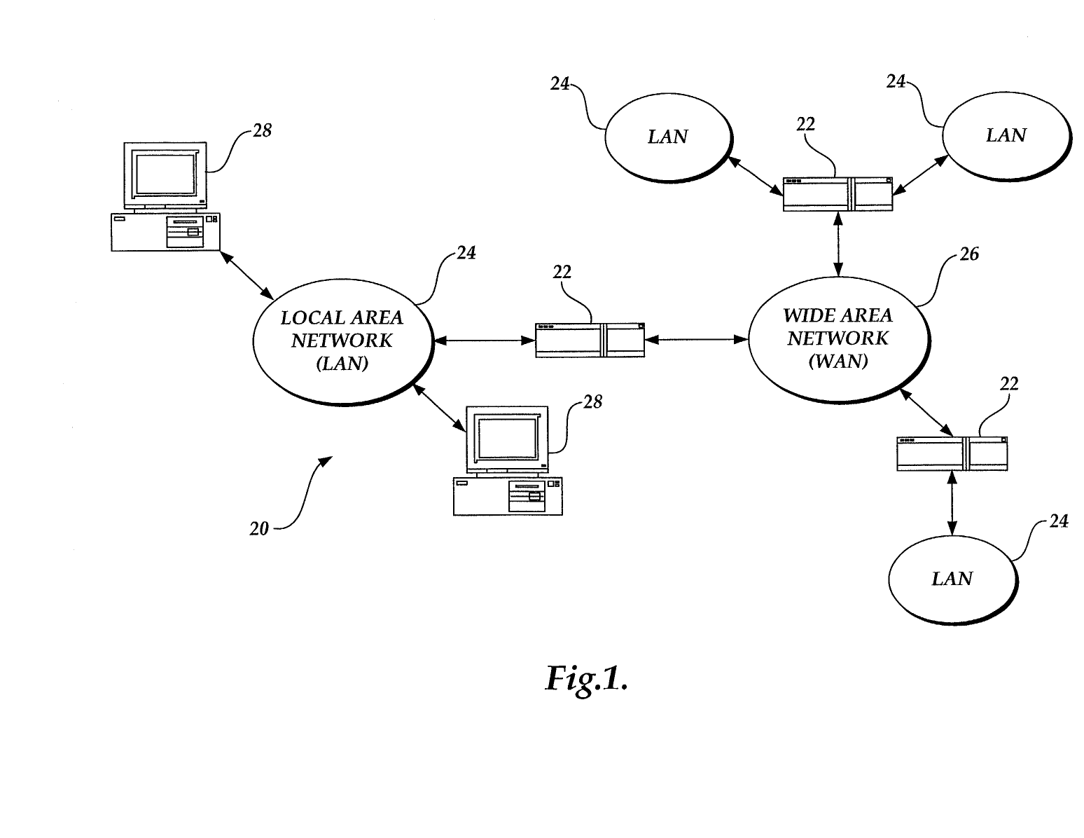

As described above, aspects of the present invention are embodied in a WWW “site”, a group of associated HTML documents, files, and databases served by a WWW server accessible via the Internet. As is well known to those skilled in the art, the term “Internet” refers to the collection of networks and routers that use TCP/IP to communicate with one another. A representative section of the Internet 20 is shown in FIG. 1, in which a plurality of local area networks (“LANs”) 24 and a wide area network (“WAN”) 26 are interconnected by routers 22. The routers 22 are special purpose computers used to interface one LAN or WAN to another. Communication links within the LANs may be twisted wire pair, or coaxial cable, while communication links between networks may utilize 56 Kbps analog telephone lines, 1 Mbps digital T-1 lines, 45 Mbps T-3 lines or other communications links known to those skilled in the art. Furthermore, computers 28 and other related electronic devices can be remotely connected to either the LANs 24 or the WAN 26 via a modem and temporary telephone or wireless link. It will be appreciated that the Internet 20 comprises a vast number of such interconnected networks, computers, and routers and that only a small, representative section of the Internet 20 is shown in FIG. 1.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HTML, or other markup languages, that are electronically stored at Web sites throughout the Internet. A WWW site is a server connected to the Internet that has mass storage facilities for storing hypertext documents and that runs administrative software for handling requests for those stored hypertext documents. A hypertext document normally includes a number of hyperlinks, i.e., highlighted portions of text which link the document to another hypertext document possibly stored at a WWW site elsewhere on the Internet. Each hyperlink is associated with a uniform resource locator “URL” that provides the exact location of the linked document on a server connected to the Internet and describes the document. Thus, whenever a hypertext document is retrieved from any WWW server, the document is considered to be retrieved from the WWW. As is known to those skilled in the art, a WWW server may also include facilities for storing and transmitting application programs, such as application programs written in the JAVA® programming language from Sun Microsystems, for execution on a remote computer. Likewise, a WWW server may also include facilities for executing scripts and other application programs on the WWW server itself.

A user may retrieve hypertext documents from the WWW via a WWW browser application program. A WWW browser, such as Netscape's NAVIGATOR® or Microsoft's Internet Explorer, is a software application program for providing a graphical consumer interface to the WWW. Upon request from the user via the WWW browser, the WWW browser accesses and retrieves the desired hypertext document from the appropriate WWW server using the URL for the document and a protocol known as HTTP. HTTP is a higher-level protocol than TCP/IP and is designed specifically for the requirements of the WWW. It is used on top of TCP/IP to transfer hypertext documents between servers and clients. The WWW browser may also retrieve application programs from the WWW server, such as JAVA applets, for execution on the client computer.

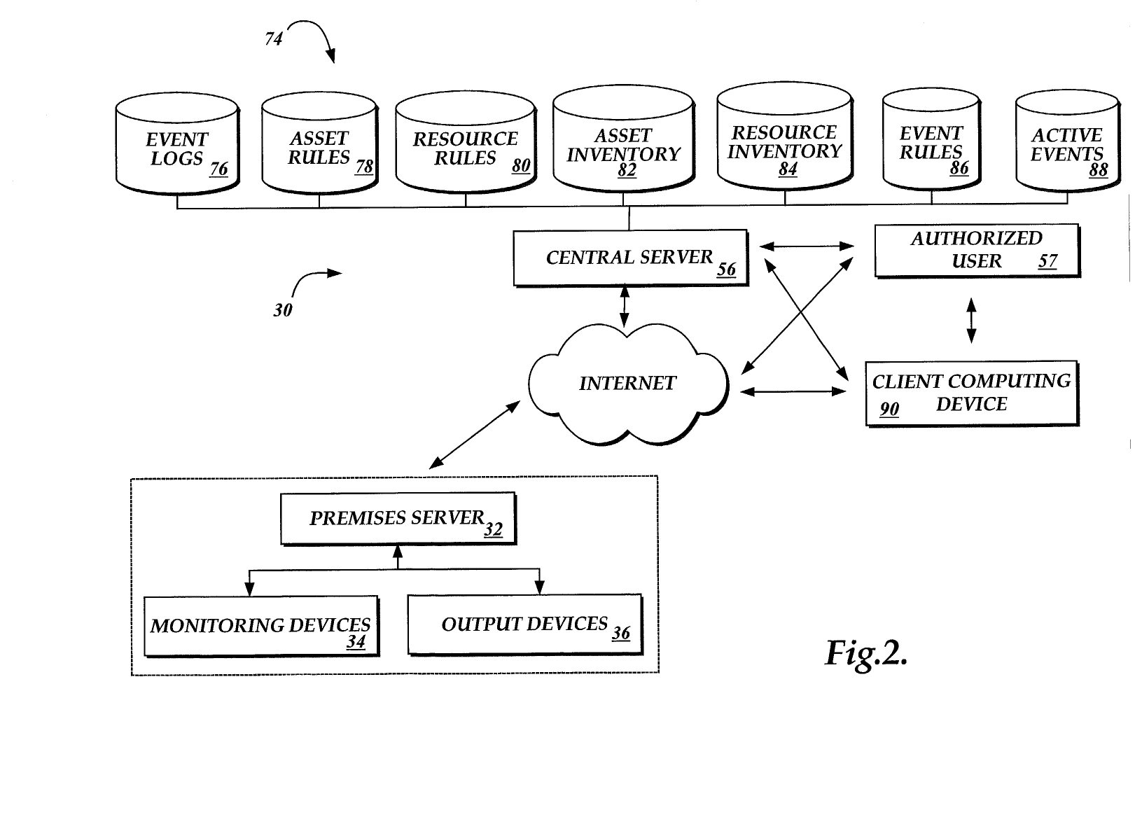

Referring now to FIG. 2, an integrated information system 30 for dynamically interacting with a remote device is illustrated in accordance with the present invention and will now be described. The system 30 is a communications network in which data is obtained from monitoring devices (hardware devices used to capture data)from a given facility, or premises. For instance, video devices, such as cameras and the like, may be installed within a premises to capture video data from a facility and provide visual surveillance of a premises, or an area within a premises. The system 30 provides a means through which user actions can be initiated via a graphical user interface, to control the collection of data and the operation of the device. The graphical user interface provides a visual environment for dynamic interaction with the hardware devices. Additionally, the graphical user interface provides for the presentation of collected live and previously-recorded monitoring data to one or more users.

With reference to FIG. 2, the system 30 includes a premises server 32 corresponding to a facility, such as a warehouse or the like, that is to be monitored by the integrated information system 30. Generally described, the premises server 32 collects and stores device data from monitoring devices and presents that data to local and remote authorized users 57 via a client computing device 90. The client computing device 90 may also obtain the device data from the central server 56, which will be described in more detail below. The premises server 32 communicates with one or more monitoring devices 34 via a network connection. A more detailed description of a network for communicating with monitoring devices 34, including the use of one or more device servers, is found in co-pending U.S. Provisional Application No. 60/281,254, entitled SYSTEM AND METHOD FOR MANAGING A DEVICE NETWORK to Alexander, and filed Apr. 3, 2001, the disclosure of which is hereby incorporated by reference.

In an illustrative embodiment of the present invention, the monitoring devices 34 can include intrusion detection devices, card readers, door strikes and contacts, access control panels, bar code scanners, video cameras, still cameras, microphones and/or similar hardware devices for capturing or generating premises-related data. One skilled in the relevant art will appreciate that any attached device capable of generating output data and/or receiving control commands could be included within the scope of this invention. It will also be understood that the monitoring devices can be integrated with other existing systems, such as pre-existing facility management or systems and components.

The premises server 32 also communicates with one or more output devices 36. In an illustrative embodiment, the output devices 36 can include audio speakers, intrusion system controllers, access system controllers, camera control receivers, and others. The output devices 36 may also include electrical or electromechanical devices that allow the system to perform actions. The output devices 36 can include computer system interfaces, telephone interfaces, wireless interfaces, door and window locking mechanisms, aerosol sprayers, and the like. Still further, the output devices 36 can include storage media including, but not limited to, optical and mass memory storage devices, such as hard disk drives, floppy disk drivers and storage cards. As will be readily understood by one skilled in the art, the type of output device is associated primarily with the type of action the system produces. Accordingly, additional or alternative output devices are considered to be within the scope of the present invention.

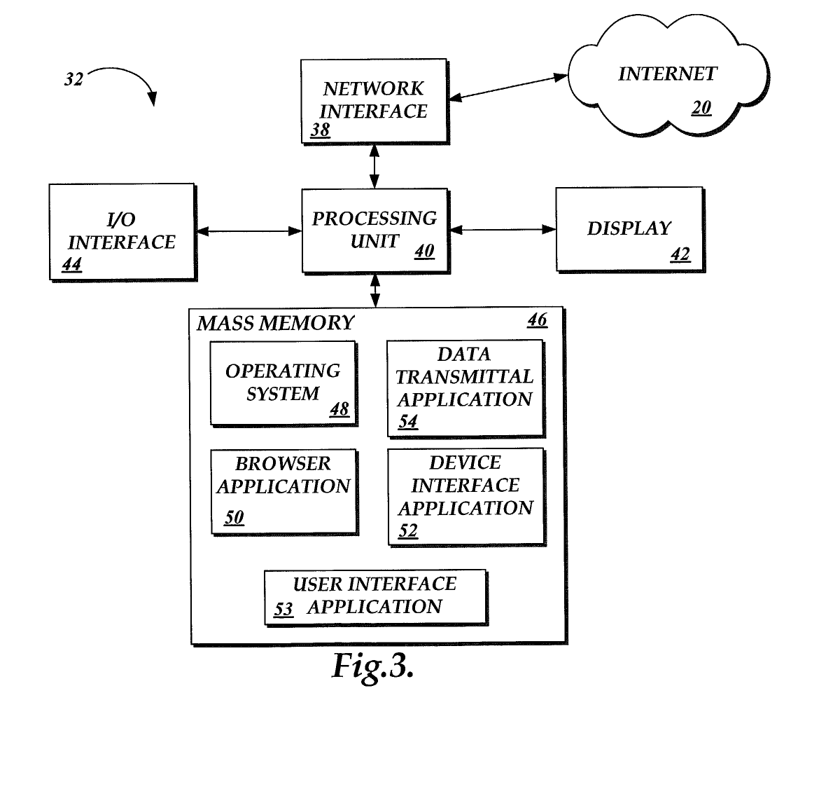

FIG. 3 is a block diagram depicting an illustrative architecture for a premises server 32 to which monitoring devices 34 may be attached. Those of ordinary skill in the art will appreciate that the premises server includes many more components then those shown in FIG. 3. However, it is not necessary that all of these generally conventional components be shown in order to disclose an illustrative embodiment for practicing the present invention. As shown in FIG. 3, the premises server 32 includes a network interface 38 for connecting directly to a LAN or a WAN, or for connecting remotely to a LAN or WAN. Those of ordinary skill in the art will appreciate that the network interface includes the necessary circuitry for such a connection, and is also constructed for use with the TCP/IP protocol, the particular network configuration of the LAN or WAN it is connecting to, and a particular type of coupling medium. The premises server 32 may also be equipped with a modem for connecting to the Internet 20. The premises server 32 may also have one or more cameras attached, as those skilled in the art will know that the present invention can be used to support multiple video inputs.

The premises server 32 also includes a processing unit 40, a display 42, a device input/output (I/O) interface 44 and a mass memory 46, all connected via a communication bus, or other communication device. The device I/O interface 44 includes hardware and software components that facilitate interaction with a variety of monitoring devices 34 via a variety of communication protocols including TCP/IP, X10, digital I/O, RS-232, RS-485 and the like. Additionally, the device I/O interface 44 facilitates communication via a variety of communication mediums including telephone landlines, wireless networks (including cellular, digital and radio networks), cable networks and the like. In an actual embodiment of the present invention, the device I/O interface 44 is implemented as a layer between the server hardware and software applications utilized to control the individual digital image devices. It will be understood by one skilled in the relevant art that alternative interface configurations may be practiced with the present invention, or that the premises server may omit the device I/O interface 44.

The mass memory 46 stores an operating system 48 for controlling the operation of the premises server 32. It will be appreciated that this component may comprise a general-purpose server operating system and a WWW browser. The mass memory 46 also stores program code and data for interfacing with the monitoring devices, for processing the monitoring device data and for transmitting the monitoring device data to a central server. More specifically, the mass memory 46 stores a device interface application 52 in accordance with the present invention for obtaining monitoring device data from any number of monitoring devices and for manipulating the data for processing by the central server. The device interface application 52 comprises computer-executable instructions that, when executed by the premises server 32, obtain and transmit device data as will be explained in greater detail below.

The mass memory 46 also stores a data transmittal application 54 for transmitting the device data to the central server and to facilitate communication between the central server and the monitoring devices 34. The operation of the data transmittal application will be described in greater detail below. Finally, the mass memory 46 stores a user interface application 53 for dynamically generating a graphical user interface by selecting various program modules such as control applets. The operation of the user interface application will be described in greater detail below. It will be appreciated that these components may be stored on a computer-readable medium and loaded into the memory of the premises server using a drive mechanism associated with the computer-readable medium.

Returning to FIG. 2, the premises server 32 is in communication with a central server 56. Generally described, the central server 56 obtains monitoring device data, processes the data and outputs the data to one or more authorized users via a client computing device 90. In an illustrative embodiment of the present invention, the communication between the central server 56 and the premises server 32 is remote and two-way.

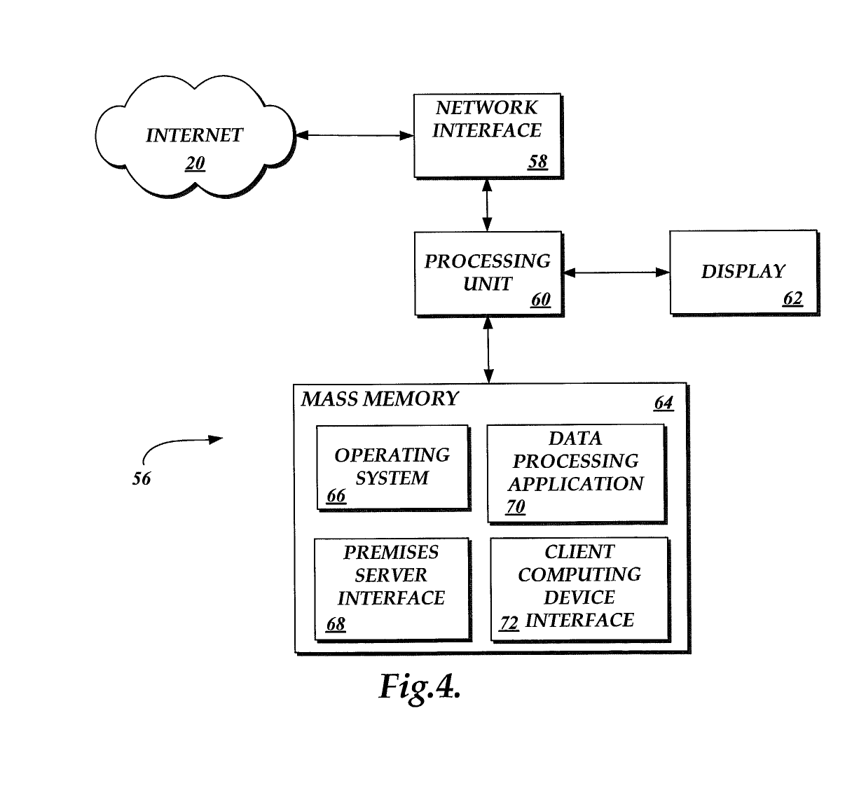

FIG. 4 is a block diagram depicting an illustrative architecture for a central server 56. Those of ordinary skill in the art will appreciate that the central server 56 includes many more components then those shown in FIG. 4. However, it is not necessary that all of these generally conventional components be shown in order to disclose an illustrative embodiment for practicing the present invention.

As shown in FIG. 4, the central server 56 includes a network interface 58 for connecting directly to a LAN or a WAN, or for connecting remotely to a LAN or WAN. Those of ordinary skill in the art will appreciate that the network interface includes the necessary circuitry for such a connection, and is also constructed for use with the TCP/IP protocol, the particular network configuration of the LAN or WAN it is connecting to, and a particular type of coupling medium. The central server 56 may also be equipped with a modem for connecting to the Internet 20 through a point-to-point protocol (“PPP”) connection or a serial-line Internet protocol (“SLIP”) connection as known to those skilled in the art.

The central server 56 also includes a processing unit 60, a display 62 and a mass memory 64, all connected via a communication bus, or other communication device. The mass memory 64 generally comprises a RAM, ROM, and a permanent mass storage device, such as a hard disk drive, tape drive, optical drive, floppy disk drive, or combination thereof. The mass memory 64 stores an operating system 66 for controlling the operation of the central server. It will appreciated that this component may comprises a general-purpose server operating system as is known to those skilled in the art, such as UNIX, LINUX™, or Microsoft WINDOWS NT®.

The mass memory 64 also stores program code and data for interfacing with the premises devices, for processing the device data and for interfacing with various authorized users. More specifically, the mass memory 64 stores a premises server interface application 68 in accordance with the present invention for obtaining data from a variety of monitoring devices and for communicating with the premises server. The premises interface application 68 comprises computer-executable instructions which, when executed by the central server 56, interfaces with the premises server 32 as will be explained below in greater detail. The mass memory 64 also stores a data processing application 70 for processing monitoring device data in accordance with rules maintained within the central server. The operation of the data processing application 70 will be described in greater detail below. The mass memory 64 further stores a client computer interface application 72 for interfacing with a variety of authorized users 57 in accordance with of the present invention. The operation of the client computer interface application 72 will be described in greater detail below. It will be appreciated that these components may be stored on a computer-readable medium and loaded into the memory of the central server using a drive mechanism associated with the computer-readable medium, such as a floppy, CD-ROM, DVD-ROM drive, or network drive.

It will be understood by one skilled in the relevant art that the premises server 32 may be remote from the premises or may be omitted altogether. In such an alternative embodiment, the monitoring devices 34 transmit the monitoring data to a remote premises server 32 or alternatively, they transmit the monitoring data directly to the central server 56. Furthermore, it will be understood by one skilled in the relevant art that the central server 56 may be located at the premises or may omitted altogether. In such an alternative embodiment, the monitoring devices 34 transmit the monitoring data to the central server or alternatively, they transmit the monitoring data directly to the client computing device 90.

Also in communication with the central server 56 is a central database 74. In an illustrative embodiment, the central database 74 includes a variety of databases including an event logs database 76, an asset rules database 78, a resource rules database 80, an asset inventory database 82, a resource inventory database 84, an event rules database 86 and an active events database 88. The utilization of the individual databases within the central database 74 will be explained in greater detail below. As will be readily understood by one skilled in the relevant art, the central database 74 may be one or more databases, which may be remote from one another. Additionally, it will be further understood that one or more of the databases 74 may be maintained outside of the central server 56.

With continued reference to FIG. 2, the central server 56 also communicates with one or more authorized users 57. In an illustrative embodiment, the authorized users 57 include one or more authorized users. Each authorized user has a preference of notification means and rights to the raw and processed monitoring data. The authorized users include premises owners, security directors or administrators, on-site security guards, technicians, remote monitors (including certified and non-certified monitors), customer service representatives, emergency personnel and others. As will be readily understood by one skilled in the art, various user authorizations may be practiced with the present invention.

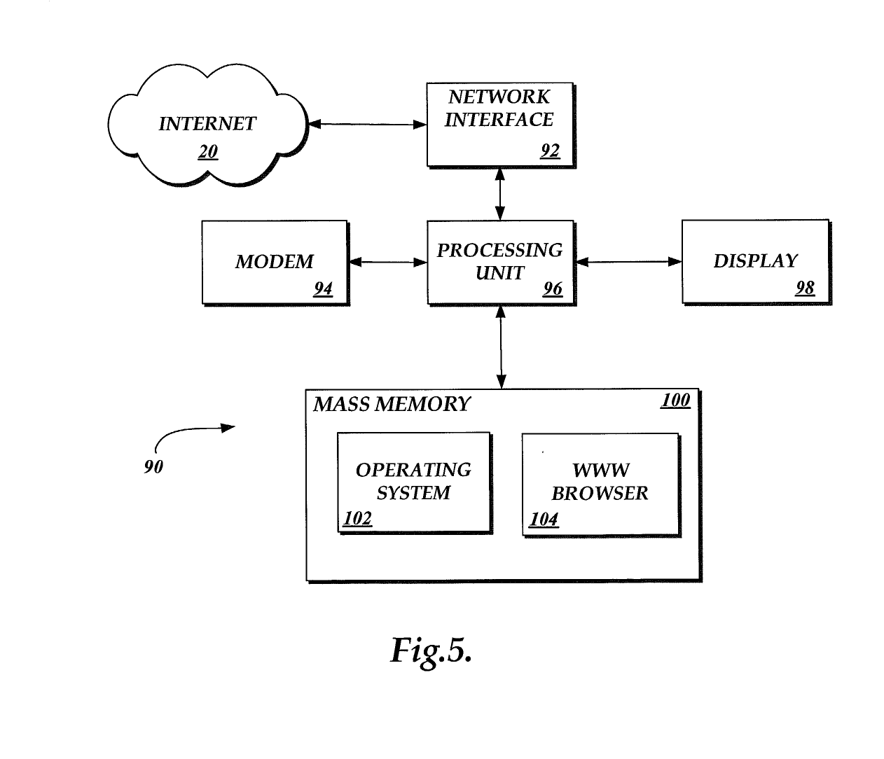

FIG. 5 is a block diagram depicting an illustrative architecture for the client computing device 90 used to present the graphical user interface. Those of ordinary skill in the art will appreciate that the client computer includes many more components then those shown in FIG. 5. However, it is not necessary that all of these generally conventional components be shown in order to disclose an illustrative embodiment for practicing the present invention. As shown in FIG. 5, the client computing device 90 includes a network interface 92 for connecting directly to a LAN or a WAN, or for connecting remotely to a LAN or WAN. Those of ordinary skill in the art will appreciate that the network interface includes the necessary circuitry for such a connection, and is also constructed for use with the TCP/IP protocol, the particular network configuration of the LAN or WAN it is connecting to, and a particular type of coupling medium. The client computing device 90 may also be equipped with a modem 94 for connecting to the Internet 20. The client computing device 90 also includes a processing unit 96, a display 98, and a mass memory 100, all connected via a communication bus, or other communication device. The mass memory 100 generally comprises a RAM, ROM, and a permanent mass storage device, such as a hard disk drive, tape drive, optical drive, floppy disk drive, or combination thereof. The mass memory 100 stores an operating system 102 for controlling the operation of the client computing device. It will appreciated that this component may comprises a general-purpose operating system as is known to those skilled in the art, such as UNIX, LINUX™, or Microsoft WINDOWS NT®. The memory 100 also includes a WWW browser 104, such as Netscape's NAVIGATOR® or Microsoft's Internet Explorer browsers, for accessing the WWW. In an actual embodiment of the present invention, the client computing device 90 interacts with the premises server 32 and the central server 56 via graphical user interfaces generated within the WWW browser application 104. Alternatively, the client computing device 90 may have one or more resident software application in mass memory for interfacing with the various components of the information system 30.

In an illustrative embodiment of the present invention, an authorized user utilizes a client computing device 90 to access one or more components of the integrated information system. The client computing device 90 include personal computers, handheld computing devices, wireless application protocol enabled wireless devices, cellular or digital telephones, digital pagers, and the like. Moreover, the central server 56 may communicate with these devices via the Internet 20 utilizing electronic messaging or Web access, via wireless transmissions utilizing the wireless application protocol, short message services, audio transmission, and the like. As will be readily understood by one skilled in the art, the specific implementation of the communication mediums may require additional or alternative components to be practiced. All are considered to be within the scope of practicing the present invention.

Generally described, the present invention facilitates the collection and processing of a variety of premises information for distribution to one or more authorized users in a highly extensible manner. The present invention provides a user interface for processing data over a monitored network. Specifically, the integrated information system 30 dynamically generates one or more control modules for facilitating a browser-enabled device to access and/or process data over a communications network. One skilled in the relevant art will appreciate that the embodiment disclosed is for illustrative purposes and should not be construed as limiting.

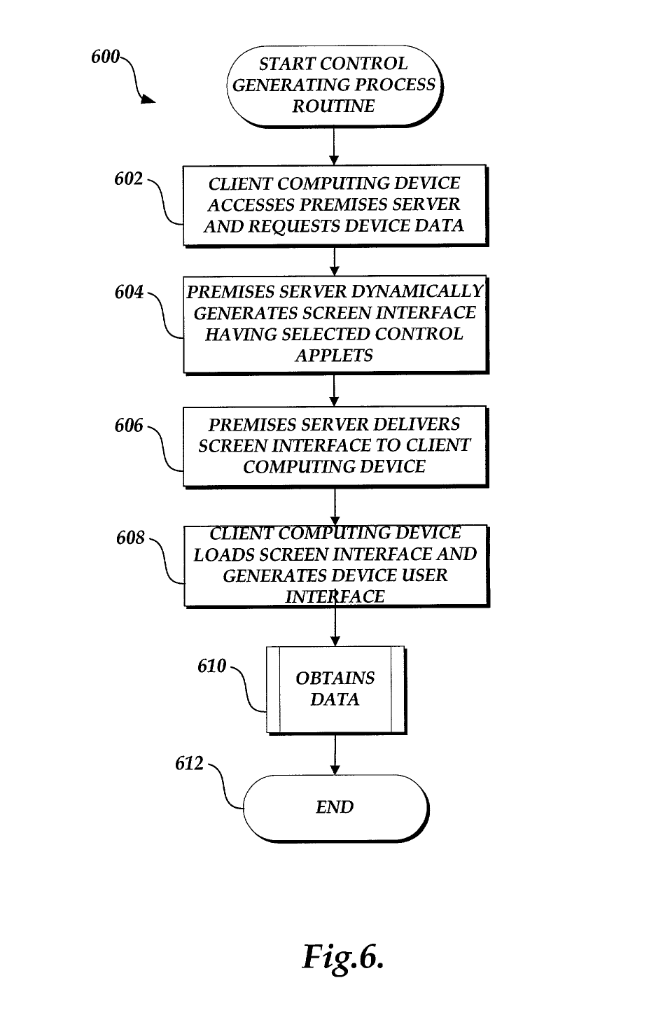

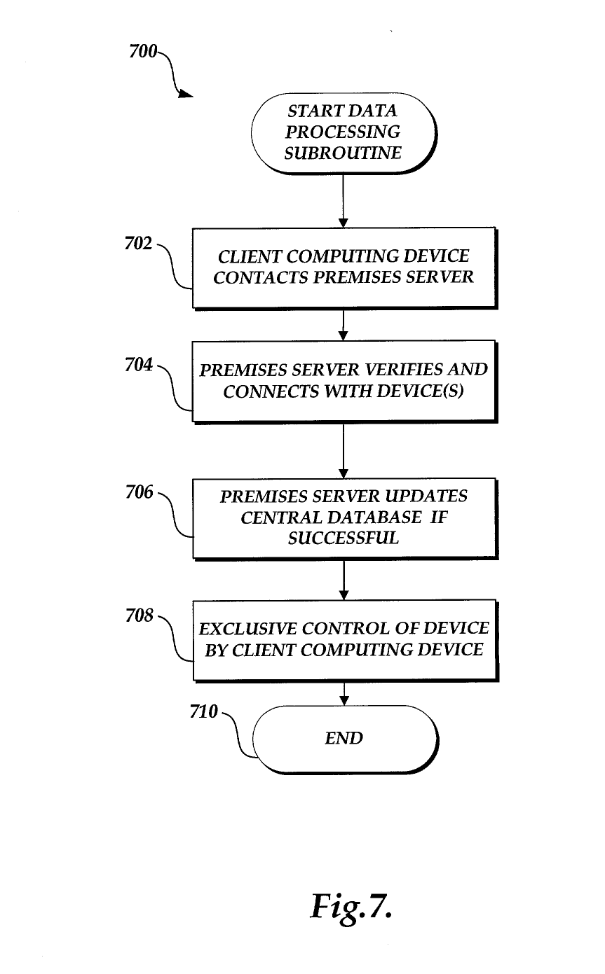

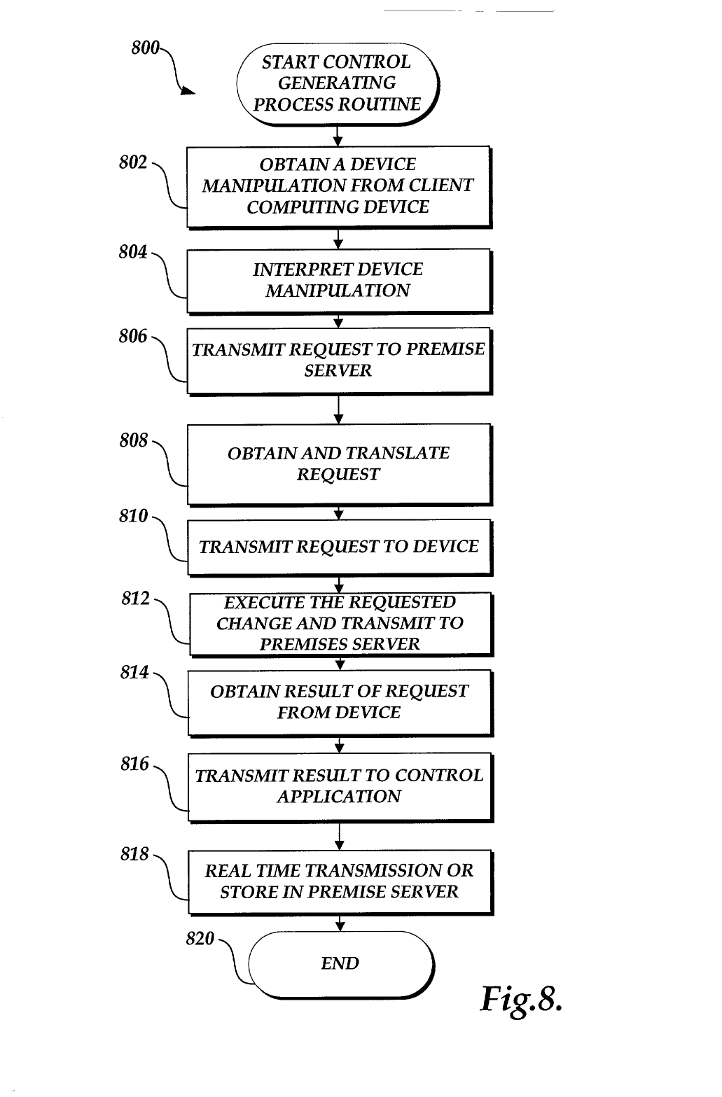

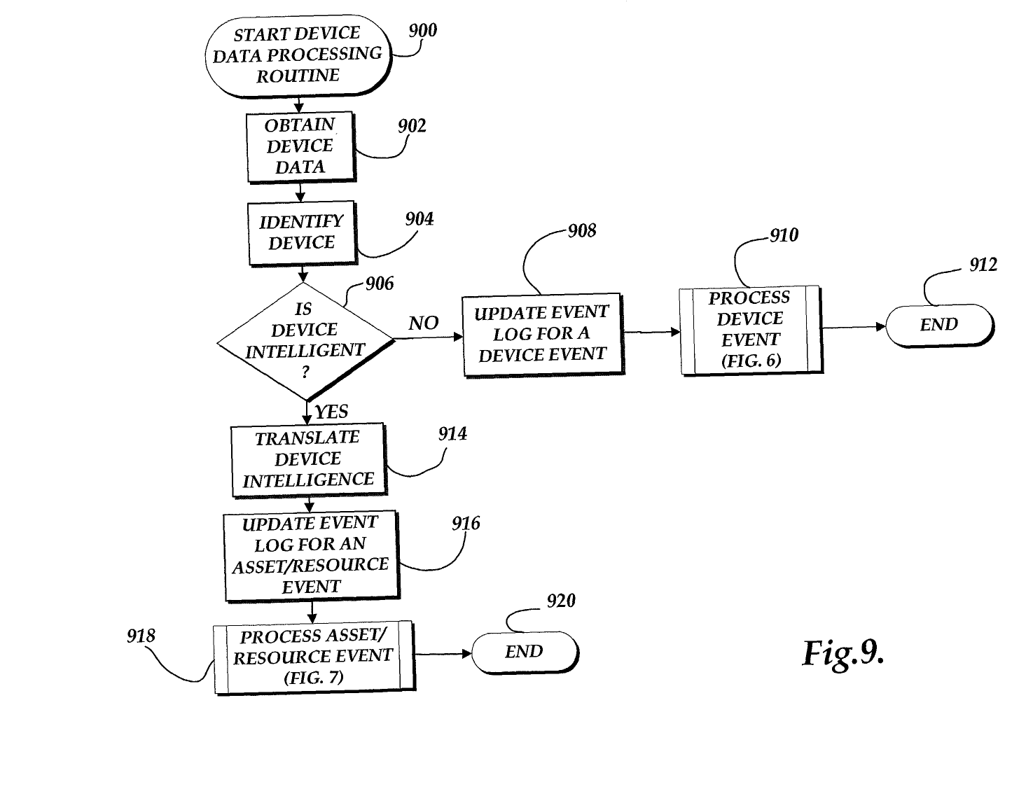

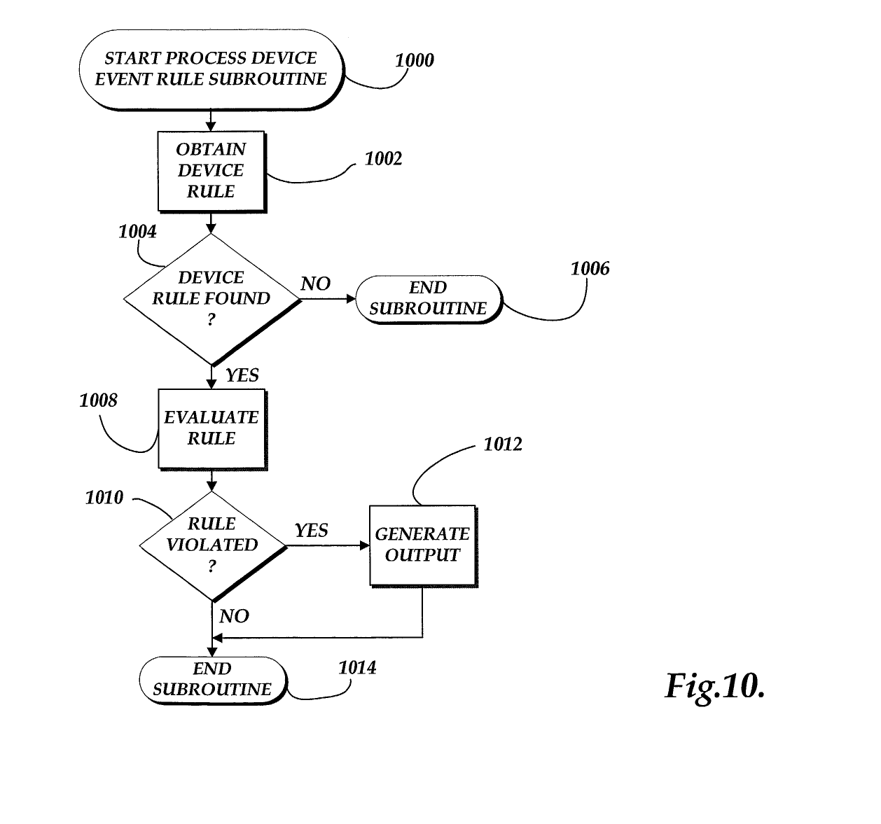

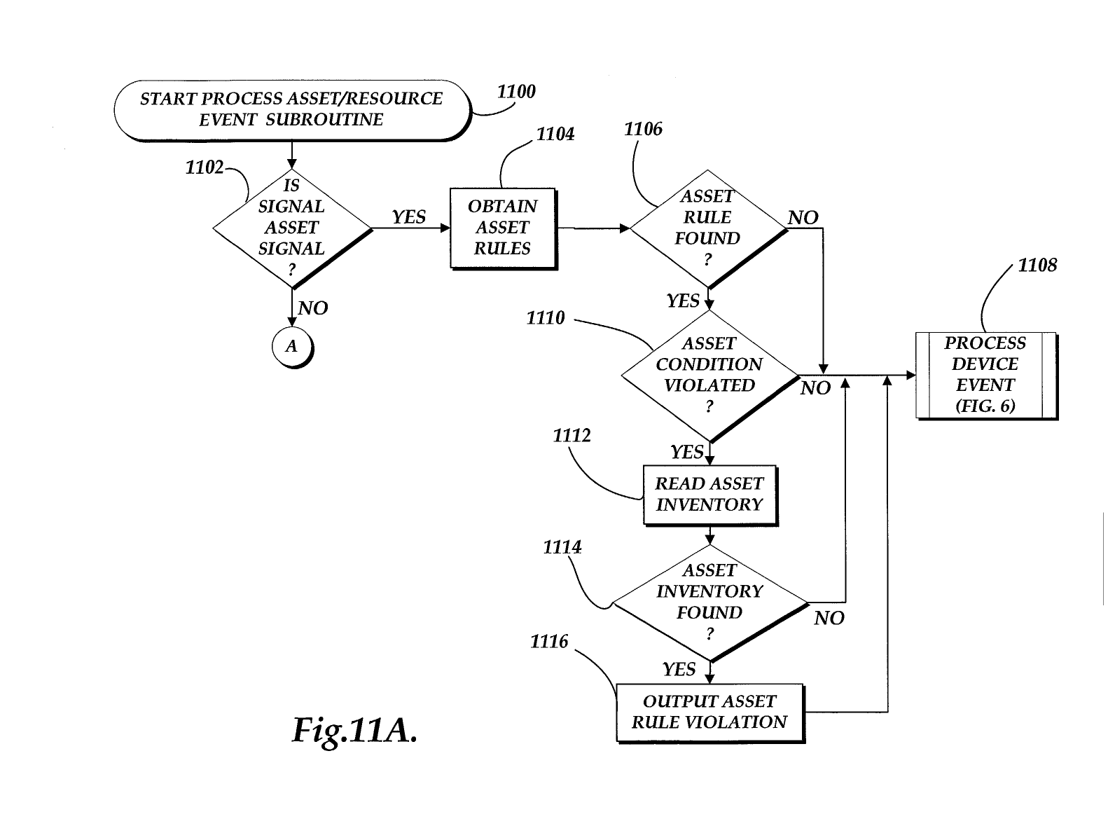

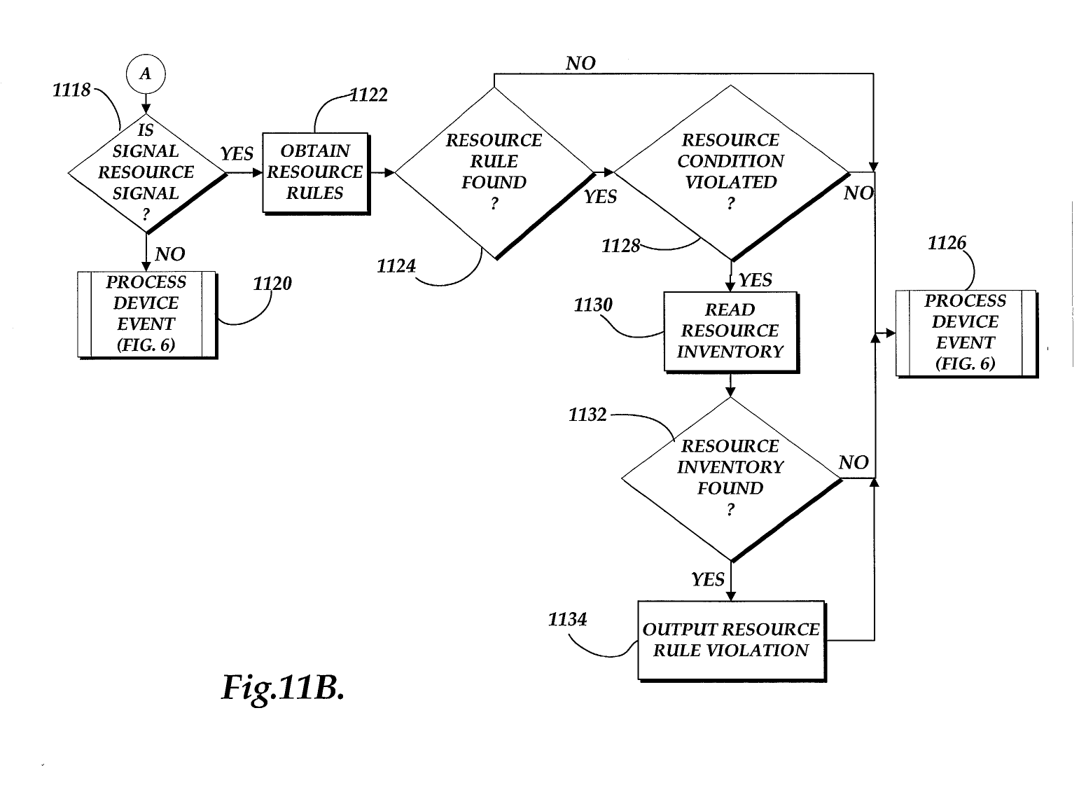

FIG. 6 is a flow diagram depicting a control generating process routine 600 in which a client computing device 90 is able to interact with a remote device, such as a monitoring device 34, in accordance with aspects of the present invention. At block 602, an authorized user 57 accesses premises server 32 and requests access to monitoring device data or other integrated information system 30 data. In an actual embodiment of the present invention, an authorized user 57 issues a request for either a particular monitoring device 34 data or a data category. For example, the client computing device 90 may include in the request a particular monitoring device identifier, such as a device type or model number. Alternatively, the client computing device 90 may request categories of data, such as archived video data, or all monitoring device data from a particular area of the premises. In an actual embodiment of the present invention, the central server 56 may deliver specific identifier codes to the client computing device 90 when the device is initiated.

The authorized user 57 accesses the premises server via a proxy server, in this case, the central server 56 where user identification and authorization information are confirmed by information stored in the central database 74. The information contained in the central database 74 authenticates user access and prevents the use of any device by more than one user simultaneously. For example, the information may state that a particular authorized user, e.g. a security director, can only gain access to certain monitoring devices such as video cameras. After a period of time determined by the rules, if no interaction with a device has occurred within a prescribed time period the session will automatically terminate. Additionally, a remote user with a prioritized level of authorization may also suspend a session by another user to gain access to a device.

Once the authorized user has gained access to the premises server 32, the premises server 32 dynamically generates a graphical user interface to be viewed by the user via the client computing device 90 at block 604. In accordance with an actual embodiment of the present invention, the user interface application 53 of the premises server 32 which dynamically generates a Web page containing one or more control applets to be run within an instance of the WWW browser 104 of the client computing device 90. The control applets include resources, such as device-specific information, that allow the client computing device 90, through the WWW browser 104, to issue the appropriate requests or commands to the premises server 32 to gain control over a certain monitoring device 34. The control applets may contain viewer applets so that viewable data from a monitoring device 34, such as a video camera, can be viewed by the client computing device 90.

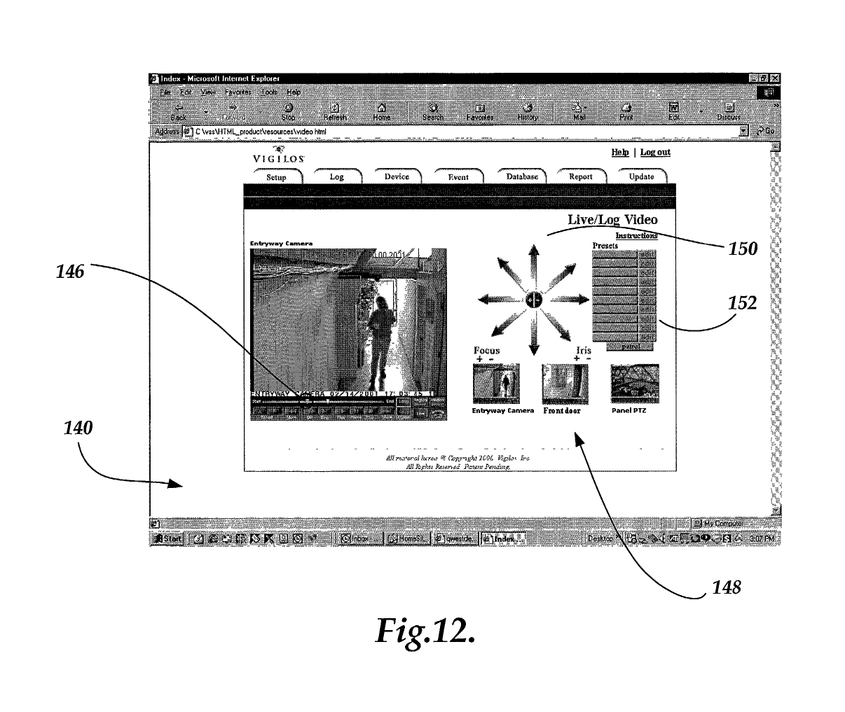

At block 606, the premises server 32 delivers the dynamically generated Web page to the client computing device 90. Once the client computing device 90 obtains the Web page, the client computing device loads the web page and generates the specific requested device user interface at block 608. In an actual embodiment of the present invention, the control applets load a graphical image, known as an interface template, designed to facilitate the user's interaction with the specific monitoring device. The interface template loaded is specific to the type of monitoring device. For example, a controllable thermostat may have a sliding scale for the desired temperature. Additionally, a video camera may use a compass rose, or other graphical representations that are visual abstractions of the device's functional capabilities. An exemplary screen display illustrative of a web page which includes a graphical user interface 140 generated dynamically by the user interface application 53 is shown in FIG. 12.

Returning to FIG. 6, once the dynamically generated web page is loaded on the client computing device 90, the authorized user 57 via the client computing device obtains the requested data from either the premises server 32 or the central server 56 at block 610. It will be appreciated by those skilled in the art that the type of data obtained by the client computing device 90 corresponds directly to the data requested by the user and to the control applets dynamically generated by the premises server. For instance, if the graphical user interface included a control applet for a thermostat, temperature data would be obtained from either the premises server 32 or the central server 56.

In an embodiment of the present invention, block 610 may include obtaining prerecorded video utilizing a graphical user interface generating by the WWW browser 104. The embedded viewer applet draws device output, images in this case, from the central server 56 to be viewed with the WWW browser 104. FIG. 12 represents a video playback user interface 140 for pre-recorded, or “logged” video dynamically generated by the user interface application in conjunction with the WWW browser 104. Users may use the graphical user interface “controls” to view data chronologically or to move to an earlier or later sequence of the recorded video data. In the embodiment shown, “controls” such as play, pause, rewind, and fast forward are utilized by the user to view data. When the video is recorded in response to an “event” defined as a violation of a user-defined rule, a condition or threshold established by a user(e.g. motion detected at a premises at 3 a.m. ), as will be described below with reference to FIGS. 9-11B, the graphical user interface includes a graphical means, such as a dot 146, for differentiating the event-triggered frames from data recorded before or after an event. As a result, a user is able to see a graphical representation of the video and a linear, time-based graph that marks the event triggering frame and the temporal relationship of the other frames to the triggering event. Additionally, all pre-recorded data includes a running time and date stamp.

In another embodiment of the present invention, block 610 may include viewing monitoring device data from multiple monitoring devices utilizing the graphical user interface generating by the WWW browser 104. FIG. 12 represents a graphical user interface 140 for the display of data from multiple devices 148 associated with a location. The specific geographic placement of a device within a facility is the location. A location may have multiple devices associated with it. Alternatively, a single device may be associated with multiple locations, as in a video recording device that has more than one location in its possible field of view. For instance, the entry to the facility may have several video cameras having different camera angles such as a front view, a side view, and a top view. When an event triggers recording of a device, video data from that device is displayed with accompanying displays of other device data obtained from other devices associated with that location. Using a mouse, a user can “right click” on a primary or auxiliary device view in order to maximize the view.

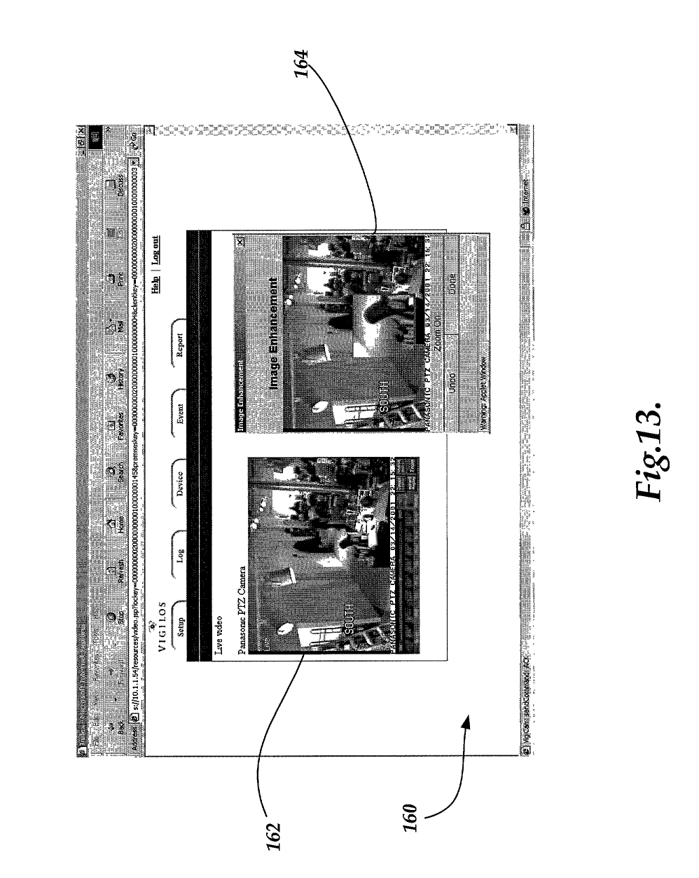

In yet another embodiment of the present invention, block 610 may include obtaining and manipulating data from the monitoring devices 34 utilizing the graphical user interface generated by the WWW browser 104. FIG. 13 represents a graphical user interface 160 for a simulated zoom manipulation of logged video data. Through the means of the graphical user interface 160, the user may select a data frame 162 and “zoom” the data frame 162 into an enlarged frame 164. The zoom effect is achieved by averaging the pixels in the selected area.

In an actual embodiment of the present invention, the client computing device gains access to or controls the monitoring device for reasons such as either viewing live video or changing the viewing window of a video camera by utilizing a data processing subroutine 700. FIG. 7 is a flow diagram illustrative of a data processing subroutine 700 utilized in accordance with the present invention. At block 702, the control applet attempts to establish communications with the premises server 32. At block 704, the premises server 32 accepts the connection request from the user and checks the dynamically generated user interface of the client computing device 90 to ensure the user is authorized to assume control of the specific monitoring device 34. If the user is allowed to control the specific monitoring device, the premises server 32 establishes a communications link, via the device interface application 52, with the specific monitoring device(s) 34. The establishment of a communication link between the premises server and the specific monitoring device is described in co-pending U.S. Patent Application Serial No. 60/281,254, filed Apr. 3, 2001, entitled “System and Method for Managing a Device Network” by Bruce Alexander.

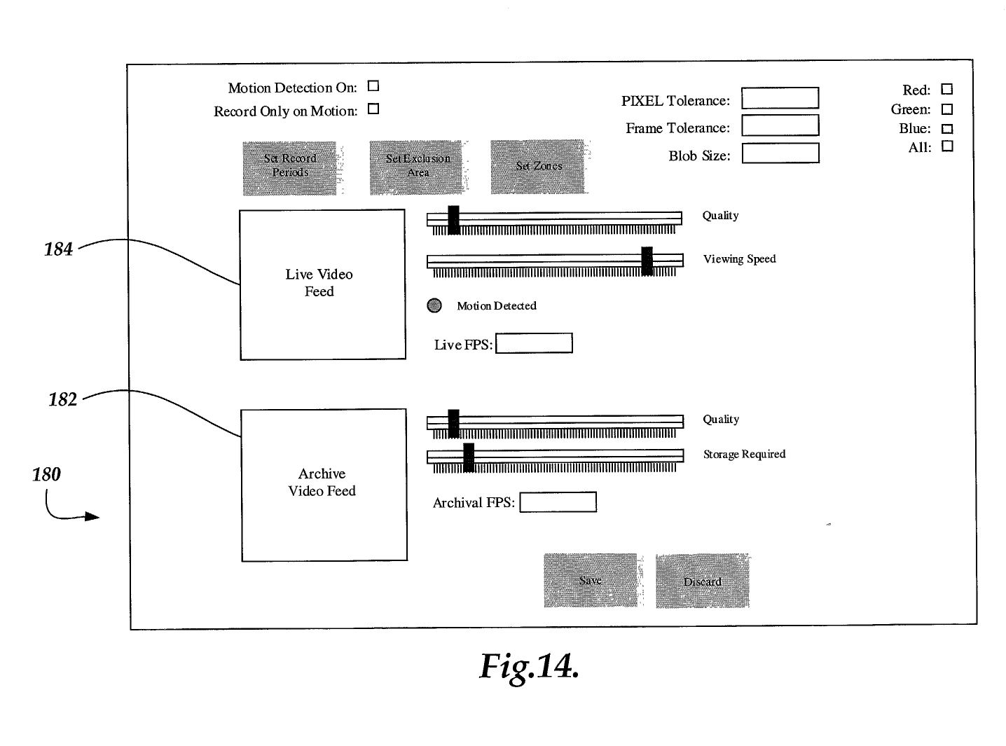

If the premises server 32 successfully connects with the monitoring device 34, the premises server 32 updates the central database 74 to indicate the authorized user is in control of the specific monitoring device and passes a successful connection message to the control applet on the client computing device 90 at block 706. Alternatively, if a communication cannot be established with the monitoring device 34, the premises server 32 returns an error message to the control applet. Additionally, the control applet can notify the user if it is connected or not connected to the specific monitoring device. At block 708, the client computing device 90 has exclusive control over the specific monitoring device(s) 34. Alternatively, in the case of viewing live video, the monitoring device streams a live data stream to the client computing device 90. Further, as shown in FIG. 14, a dynamically generated graphical user interface 180 is depicted which includes multiple control applets for viewing pre-recorded device data 182 and live device data 184. In an actual embodiment, the client computing device, through the graphical user interface dynamically generated by routine 600, can control the operation of a specific monitoring device 34, which will be described in more detail below with reference to FIG. 8. The subroutine 700 terminates at block 710.

FIG. 8 is a flow diagram depicting a device manipulating process routine 800 in which a client computing device is able to control a remote device in accordance with aspects of the present invention. At block 802, the control applet, selected specifically by the user interface application, obtains a device manipulation, e.g. request to move the video camera, from the user interface 120. Once the control applet obtains a device manipulation, the control applet interprets the device manipulation, e.g. have the video camera pan left, at block 804. In an actual embodiment of the present invention, the user requests a change, e.g. manipulation, in the state of the specific monitoring device by pointing to a specific location on the user interface via the browser 104 with a pointing device or other means. For instance, the user can effect a directional movement in a video camera or alter an environmental control setting, such as the temperature on a thermostat. At block 806, the control applet passes the request to the specific monitoring device 34 via the premises server 32 through the network connection established earlier. The transfer of data may be facilitated indirectly through the central server 56, or may be directly transferred to the premises server 32 through a communication medium such as the Internet 20.

At block 808, the premises server 32 evaluates the command and the device interface application 52 and translates the requested action into device-specific protocol commands. In an illustrative embodiment of the present invention, the device interface application 52 maintains a set of device specific commands for controlling specific monitoring devices 34. If the command is not recognized then the premise server 32 rejects the request and notifies the control applet of the error. Otherwise the premises server 32 transmits the request to the monitoring device 34 via the device interface application 52 at block 810. The monitoring device 34 attempts to execute the requested change in state, e.g. pan left, and may communicate an error or confirmation information back to the central server 56. If the premises server 32 receives error information from the device 34, it will communicate that information back to the control applet. At block 812, the monitoring device 34 executes the requested change of state and transmits monitoring data in the altered or changed state to the premises server 32.

In an illustrative example of the kind of manipulation that can be affected on a monitoring device, whereby the hardware device is a video camera, the control applet communicates with a camera that is capable of utilizing settings for functions such as pan, tilt, and zoom (“PTZ”) video directional control. The camera capabilities information is contained in a device interface database maintained by the central server 74. The Web page relays the parameter information necessary for the activation of the camera and the control of PTZ or other camera functions. Video images are captured by the grabber software described below, and stored on the central server and/or client computing device 90 as video frames. Images are uploaded from the grabber software to the WWW browser for viewing on demand.

The following description exemplify representative elements of a graphical user interface 140 for controlling a PTZ camera in accordance with the present invention. In an illustrative embodiment of the invention, the PTZ camera includes preset information 152 which relates to a default pan, tilt, or zoom positioning of the camera, as well as focus and iris control. The user activates the presets through movement of the mouse. When controlling a device such a video camera, the user needs a way to establish the intensity of the movement of the device. This intensity can be defined as degree or strength of the motion of the device. The user interface provides a graphical controller, such as a compass rose 150, to communicate the intensity, i.e. the speed, duration, and direction, to the monitoring device.

The compass rose 150, which is illustrated in FIG. 12, provides a directional template in which to affect a manipulation in the monitoring device such as the video camera. The center of the compass rose is the origin of the Cartesian coordinate system (0, 0) and corresponds to the default settings of the device presets, while the arms of the compass rose indicate the direction of movement. In the embodiment shown, “clicking” the mouse in the direction of one of the arrows of the compass rose transmits a command to the control applet. A “click” toward the outside of the compass rose produce greater change, e.g. movements, in the monitoring device than a “click” toward the center of the compass rose so that the degree of movement of the monitoring device, in this case the speed at which the camera pans or tilts, is directly related to the user's interaction with the on-screen graphic. The graphical user interface, namely the compass rose, provides a dynamic interaction between the remote user and the video camera.

In an actual embodiment of the present invention, the direction, speed, and duration of movement of the video camera is communicated by placing a graphical cursor on the compass rose 150 at a location corresponding to the desired direction of movement, and then activating a pointer device, e.g. the mouse, to communicate that position to the control applet. The distance of the cursor device from the compass rose origin point is calculated and translated into a percentage of the total possible distance. For instance, if the maximum possible distance from the origin point is 200 units of measure, and the cursor device is 50 units from the origin, then the intensity (speed and duration) of the movement would be 25% of the maximum speed and duration possible for the device being controlled.

Once the user inputs the desired movement by activating the pointer device, the control applet of the client computing device 90 communicates the intensity and direction of movement to the premises server 32. The premises server 32 correlates the device definition data with the movement information received from the control applet and determines an actual direction, speed, and duration of movement. For instance, one video camera type has a default movement duration of 2.2 seconds and maximum speed setting of 7 units. If the user points to a position on the left arm of the compass rose 50 units from the compass rose origin, meaning the camera should pan left, the premises server calculates the actual duration of movement by multiplying the maximum duration by the intensity of movement (2.2*25%), giving an actual duration of 0.55 seconds. The same process is also applied to the speed of the movement (7*25%), giving a speed of 1.75 (rounded to 2). Accordingly, the device interface application 52 on the premises server 52 instructs the camera to pan left for 0.55 seconds at a relative speed of 2.

After the premises server obtains the result of the request from the monitoring device 34 via the device interface application 52 at block 814, the premises server 32 transmits the results via the data transmittal application 54 to the control applet at the client computing device 90 at block 816. The user via the client computing device may then be able to view real time transmission of the output data of the altered monitoring device at block 818. Alternatively, the output data of the altered monitoring device can be stored at the premises server 32. Routine 800 ends at block 820.

In an actual embodiment of the present invention, a process that accepts output data from the monitoring device, a frame grabber in the case of a video recording device, stores the data on the client computing device by transmitting the device data via a standard WWW browser communication channel. The frame grabber is a software device that communicates directly with the video camera and stores raw video in an acceptable image format, such as a bitmap, joint photographic expert group (“JPEG”), or the like. In some cases, the device output will be gathered by the premises server 32 and transmitted to the device control applet via the data transmittal application 54. A viewer applet displays the altered state (i.e. the different video image of the video camera after panning left). It will be appreciated by those skilled in the art that the premises server 32 can send the device output data to the central server 56 to be stored and archived in the central database for later viewing.

While the illustrative embodiments have been describe using a video camera, one skilled in the relevant art will appreciate that the process of the present invention is not limited to video cameras. Any device capable of control can be managed through this process. Additionally, a common user interface may be used to manage multiple devices of the same or similar type. Moreover, one skilled in the relevant art will further appreciate that the present invention may be implemented in a different network configuration, such as a dedicated device control network or a WAN in which a dedicated device server is utilized. By utilizing the system of the present invention, data is requested and displayed through the user interface giving the effect of a local resource. Information at the highest level (the application) produces a change or obtains data from the lowest level (hardware communication).

Having described the general operation and benefits of generating a graphical user interface utilized for requesting and displaying monitoring data, and controlling monitoring devices, a general description of an integrated information system 30 will be explained. Accordingly, the disclosed embodiment is done solely for illustrative purposes and should not be considered limiting.

In an actual embodiment of the present invention, the monitoring device data is categorized as asset data, resource data or device data. Asset data is obtained from a monitoring device corresponding to an identifiable object that is not capable of independent action. For example, asset data includes data obtained from a bar code or transponder identifying a particular object, such as a computer, in a particular location. Resource data is obtained from a monitoring device corresponding to an identifiable object that is capable of independent action. For example, resource data includes data from a magnetic card reader that identifies a particular person who has entered the premises. Event data is obtained from a monitoring device corresponding to an on/off state that is not correlated to an identifiable object. Event data is a default category for all of the monitoring devices. As will be readily understood by one skilled in the relevant art, alternative data categorizations are considered to be within the scope of the present invention.

The monitoring device data is obtained by the monitoring devices 34 and transmitted to the premises server 32, which then communicates with the central server 56. The central server 56 receives the monitoring device data and processes the data according to a rules-based decision support logic. In an actual embodiment of the present invention, the central server 56 maintains databases 76 having logic rules for asset data, resource data and event data. Moreover, because the monitoring device data is potentially applicable to more than one authorized user, multiple rules may be applied to the same monitoring device data. In an alternative embodiment, the rules databases 76 may be maintained in locations remote from the central server 56. One skilled in the art will recognize that the evaluation of device information collected from the monitoring devices 34 can be performed at any point and that the description given here is meant to depict one of several alternatives. For instance, rule evaluation can be performed at the premises server 32, and notifications can be sent from each processing location.

In the event the processing of the monitoring device rules indicates that action is required, the central server 56 generates one or more outputs associated with the rules. The outputs include communication with indicated authorized users 57 according to the monitoring device data rules. For example, an authorized user 57 may indicate a hierarchy of communication mediums (such as pager, mobile telephone, land-line telephone) that should be utilized in attempting to contact the user. The rules may also indicate contingency contacts in the event the authorized user cannot be contacted. Additionally, the rules may limit the type and/or amount of data the user is allowed to access. Furthermore, the outputs can include the initiation of actions by the central server 56 in response to the processing of the rules.

FIG. 9 is a flow diagram illustrative of a device decision support routine 900 for processing the monitoring device data in accordance with the present invention. At block 902, the central server 56 obtains an input from a monitoring device 34. In an actual embodiment of the present invention, the input is obtained by the device interface application 52 of the premises server 32 and transmitted via the data transmittal application 54 to the central server 56. Alternatively, the central server 56 may poll the premises server 32 to obtain monitoring device data from the monitoring devices. At block 904, the central server 56 identifies the device processing the data. The identification may be accomplished by determining a network address from which the input originated and which is assigned to the specific devices, or by reading other identification data that can be included with the data input.

At decision block 906, a test is performed to determine whether the device data includes intelligence data. In an actual embodiment of the present invention, intelligent data is characterized as asset data or resource data, because the data contains information identifying the object. On the other hand, data that does not contain any information identifying an object is not considered intelligent. If the device is not determined to be intelligent or if the device cannot identified, at block 908, an event log database 76 is updated to reflect the input data. At block 910, the central server 56 processes the data according to a process device event subroutine. The routine 900 terminates at block 912.

FIG. 10 is a flow diagram illustrative of a process device event subroutine 1000 in accordance with the present invention. At block 1002, the central server 56 obtains the monitoring device rules. In an actual embodiment, the monitoring device rules are stored in an event rules database 86 in communication with the central server 56. The rules contain data indicating one or more ranges for determining a rule violation. In a broad sense, a rule violation indicates that an event has occurred for which a notification is required. The ranges correspond to the type of data produced by the monitoring device. For example, if a monitoring device 34 is capable of only two stages (e.g., on or off), the rule may indicate that existence of one stage, e.g. “on”, is a violation. The rules may also include an indication that one or more monitoring device rules must also be considered before the rule is determined to be violated. For example, a rule corresponding to a glass break detector may indicate that a motion detector signal must be detected before the rule is violated. As will be readily understood by one skilled in the relevant art, additional or alternative rule types are considered to be within the scope of the present invention.

At decision block 1004, a test is performed to determine whether a device rule is found. If no rule is found, the process terminates at block 1006. If, however, a device rule is found, at block 1008, the central server 56 evaluates the rule according to the data received from the monitoring device 34. In an illustrative embodiment, the rules may include preset or default rules maintained by the central server 56. Additionally, the rules may include independently created rules by one or more authorized users. Moreover, one or more authorized users may be given the authority to modify or update rules via a user interface.

At decision block 1010, a test is performed to determine whether the device rule is violated. If the rule is violated, at block 1012, the central server 56 creates a rule violation output. In an actual embodiment of the present invention, the rules violation output instructions are included in the rule. The instructions include a list of the authorized users 57 to notify in the event of a rule violation and a hierarchy of which communication medium and devices should be utilized to contact each authorized user. For example, the rules may be in the form of logical if/then statements implementing an iterative hierarchy for establishing communication with an authorized user. Moreover, the instructions may also indicate the extent of the data that that authorized user has access to. For example, the output may include the generation of a call to the premises owner's mobile device, the paging of an on-site monitor and a land-line telephone call to the public authorities. Alternatively, the central server may also maintain an output database indicating the output instructions corresponding to each rule.

In addition to generating communications, the rules violation output may also instigate an integrated system response. For example, in the case of an intrusion, a dye may be sprayed on the intruder from an aerosol sprayer. Additionally, the system may sound an audible alarm and directly dial emergency personnel. In an other example, if the system rules violations is a medical emergency, the central server 56 may call an ambulance, turn on lights within the premises, and unlock the doors to facilitate entry by the emergency personnel.

Once the central server 56 has generated the rules violation output at block 1012 or if the event rule is not violated at block 1010, the subroutine 1000 terminates at block 1014.

Returning to FIG. 9, if at block 906, the device data includes intelligence information, at block 914, the intelligence is translated from the monitoring device data. At block 916, the event logs database 76 is updated to reflect the input data. At block 918, the central server 56 processes the data according to a process asset/resource event subroutine. The routine 900 terminates at block 920.

FIGS. 11A and 11B are flow diagrams illustrative of a process asset or resource event subroutine 1100 in accordance with the present invention. With reference to FIG. 11A, at decision block 1102, a test is performed to determine whether the input signal is asset data. If the signal is identified as asset data, at block 1104, the asset rules are obtained. In an actual embodiment of the present invention, the asset rules are maintained and retrieved from an asset rules database 80. At block 1106, a test is performed to determine whether an asset rule is found. If no asset rule is found for the asset, the monitoring device data is processed as a device event at block 1108. In an actual application of the present invention, the device event is processed as described above with respect to the device event processing subroutine 1000 (FIG. 10). In an illustrative embodiment of the present application, in the event the asset rule processing cannot be completed, the monitoring device is still processed as a device-level event.

If an asset rule is found, at decision block 1110, a test is performed to determine whether the asset rule is violated. In an actual embodiment of the present invention, the asset rule contains data allowing the central server 56 to determine a rule violation. For example, an asset rule may contain information indicating a requirement of both a particular object (e.g., a computer) performing an action (e.g., logged into a network) for a violation. Additionally, the asset rule may indicate that additional device, resource or asset rules may be considered prior to determining whether the rule has been violated. As explained above, the rules may include preset rules maintained by the central server and user implemented/modified rules.

If the rule has not been violated, the monitoring device data is processed as a device event at block 1108. It will be generally understood by one skilled in the relevant art, that processing the rule as a both an asset and a device event allows for multiple purpose processing of the monitoring device data, such as the detection of a specific object and the detection of an object.

If the asset rule has been violated, at block 1112, the central server 56 reads a known asset inventory to identify the asset. In an actual embodiment of the present invention, central server maintains and reads from an asset inventory database 82. At decision block 1114, a test is performed to determine whether the asset is found in the asset inventory. If the asset is not found, the system defaults to processing the monitoring device data as a device event at block 1108. If the asset is found in the asset inventory, at block 1116, central server 56 outputs the asset violation. In an actual embodiment of the present invention, the asset rule contains instructions for generating output in the event of a rule violation to one or more authorized users. The instructions also contain a hierarchy of communication mediums and communication devices to attempt to contact the authorized user. Additionally, the instructions may contain alternative contact personnel if central server cannot contact the authorized user. Moreover, as explained above, the output may also instigate action by the integrated system. At block 1108, the monitoring device data is processed as a device event.

With reference to FIG. 11B, if the signal is not determined to be asset data at block 1102 (FIG. 11A), at decision block 1118, a test is done to determine whether the inputted signal is resource data. If the signal is not identified as resource data, at block 1120, the monitoring device data is processed as a device event. In an actual application of the present invention, the device event is processed as described above with respect to the device event processing subroutine 1000 (FIG. 10). If the signal is identified as resource data, at block 1122, the resource rules are obtained. In an actual embodiment of the present invention, the resource rules are maintained and retrieved from a resource rules database 80. At block 1124, a test is performed to determine whether a resource rule is found. If no resource rule is found for the resource, the monitoring device data is processed as a device event at block 1126.

If a resource rule is found, at decision block 1128, a test is performed to determine whether the resource rule is violated. In an actual embodiment of the present invention, the resource rule contains data allowing the central server to determine a rule violation. Additionally, the resource rule may indicate that additional device, resource or asset rules may be considered prior to determining whether the rule has been violated. If the rule has not been violated, at block 1126, the monitoring device data is processed as a device event. It will be generally understood by one skilled in the relevant art, that processing the rule as a both a resource and a device event allows for multiple purpose processing of the monitoring device data.

If the resource rule has been violated, at block 1130, the central server 40 reads a known resource inventory to identify the resource. In an actual embodiment of the present invention, central server 40 maintains and reads from a resource inventory database 84. At decision block 1132, a test is performed to determine whether the resource is found in the resource inventory. If the resource is not found, the system defaults to processing the monitoring device data as a device event at block 1126. If the resource is found in the resource inventory, at block 1134, central server 56 outputs the resource violation. In an actual embodiment of the present invention, the resource rule contains instructions for generating output in the event of a rule violation to one or more authorized users. The instructions also contain a hierarchy of communication mediums and communication devices to attempt to contact the authorized user. Additionally, the instructions may contain alternative contact personnel if central server 56 cannot contact the authorized user 57. Moreover, as explained above, the output may also instigate action by the integrated system. At block 1126, the monitoring device data is processed as a device event (FIG. 10).

The monitoring devices 34 devices may include any number or combination of environmental output as well as input devices. Information collected by the individual devices is collected and stored locally by a premises server. The information is collected according to rules defined by the user.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for interacting with a remote device comprising:
obtaining a request corresponding to controlling one or more identifiable remote devices;
generating a graphical user interface operable to control the remote device, wherein controlling said device includes accessing said remote device and issuing instructions;
obtaining user control instructions from said graphical user interface;
transmitting remote device control data corresponding to said user control instructions; and
obtaining remote device data generated by said remote device.

2. The method of claim 1, wherein generating a graphical user interface includes dynamically generating a graphical user interface.

3. The method of claim 2, wherein dynamically generating a graphical user interface includes:
identifying a remote device corresponding to said request;
selecting a program module corresponding to said identified remote device from a plurality of program modules, said program module operable to control said remote device;
generating a screen interface including said selected program module, said program module including a graphical user interface component corresponding to said requested remote device.

4. The method of claim 3, wherein dynamically generating a graphical user interface includes:
identifying two or more remote devices corresponding to said request;
selecting a program module corresponding to each identified remote device from a plurality of program modules, said program modules operable to control said remote device;
generating a single screen interface containing all program modules, said program modules operable to generate graphical user interface components corresponding to each requested remote device.

5. The method of claim 4, wherein said user control instructions controls the operation of all of said remote devices.

6. The method of claim 2, wherein said graphical user interface is a Web page.

7. The method of claim 2, wherein obtaining a request corresponding to controlling one or more identifiable remote devices includes:
obtaining a request for monitoring data corresponding to said remote device.

8. The method of claim 2, wherein obtaining a request corresponding to controlling one or more identifiable remote devices includes:
obtaining a request to transmit data to said remote device.

9. The method of claim 8, wherein said transmitted data causes said remote device to move.

10. The method of claim 1, wherein transmitting control data includes;
transmitting a request for accessing data from said remote device; and
transmitting authorization for access to said remote device.

11. The method of claim 1, wherein obtaining remote device data generated by said remote device includes:
obtaining real-time data generated by said remote device.

12. The method of claim 1, wherein obtaining remote device data generated by said remote device includes:
obtaining pre-recorded data generated by said remote device

13. The method of claim 1, wherein said remote device is a video camera, and wherein obtaining remote device data includes obtaining video data from said video camera.

14. The method of claim 13, wherein transmitting control data includes transmitting data manipulating said video camera

15. The method of claim 1, wherein transmitting data includes manipulating operating parameters of said remote device using said graphical user interface; and wherein obtaining remote device data includes obtaining remote device data generated by said remote device based on said manipulated operating parameters.

16. The method of claim 15, wherein said graphical user interface includes a graphical means for manipulating said operating parameters of said remote device, said graphical means operable to receive user inputs corresponding to said manipulation.

17. The method of claim 16, wherein said remote device is a video camera, and wherein said graphical means is a graphical controller including graphical representation of a compass having an origin and directional indicators.

18. The method of claim 17, wherein said graphical controller is operable to communicate the intensity of said manipulation, said intensity based on the distance away said user input is from said origin.

19. The method of claim 1, wherein obtaining user control data includes obtaining a request for manipulating operating parameters of said remote device; and
wherein transmitting remote device control data includes translating said request into device specific commands, and transmitting said device specific commands to said remote device operable to change said operating parameters of said remote device.

20. The method of claim 18, wherein said remote device data generated by said remote device based on said changed operating parameters is real-time data.

21. The method of claim 1, wherein said remote device is selected from the group consisting essentially of intrusion detection devices, card readers, door strikes and contacts, access control panels, bar code scanners, video cameras, still cameras, and microphones.

22. The method of claim 1, wherein said remote device can be locked, thereby preventing the simultaneous submission of instructions by more than one user.

23. A computer-readable medium having computer-executable instructions for performing the method recited in any one of claims 1-22.

24. A computer system having a processor, a memory, and an operating environment, said computer system operable to perform the method recited in any one of claims 1-22.

25. A computer-readable medium having computer-executable components for dynamically interacting between at least one remote device and a computing device, comprising:
a user interface application operable to dynamically generate a graphical user interface corresponding to the remote device;
a device interface application operable to communicate device data from the remote device, and operable to manipulate said data; and
a data transmittal application operable to transmit said data to the computing device, and to facilitate communication between the remote device and the computing device.

26. The computer readable medium of claim 25, wherein said computing device is a server computer.

27. The computer readable medium of claim 25, wherein said computing device is a client computer.

28. The computer readable medium of claim 25, wherein said remote device is selected from the group consisting essentially of intrusion detection devices, card readers, door strikes and contacts, access control panels, bar code scanners, video cameras, still cameras, and microphones.

29. A method for dynamically generating a user interface for controlling at least one remote device comprising:
obtaining a request to control at least one pre-selected remote device;
selecting a program module corresponding to said pre-selected remote device from a plurality of program modules, said program module operable to control said remote device;
transmitting a screen interface with said program module;
wherein said screen interface containing said program module is operable to generate a graphical user interface when loaded within a browser application.

30. The method of claim 29, wherein said request to control includes two or more pre-selected devices, and wherein said screen interface is an integrated screen interface containing said program modules, said program modules operable to generate a graphical user interface corresponding to said requested remote device when said single screen interface is loaded on a browser application.

31. The method of claim 29, wherein said screen interface is a Web page.

32. The method of claim 29, wherein said pre-selected remote device is a video camera having pan-tilt-zoom functionality, and wherein said graphical user interface is operable to control said pan-tilt-zoom functionality of said video camera and to view data from said video camera.

33. The method of claim 29, wherein said pre-selected remote device is a temperature control device, and wherein said graphical user interface is operable to control said change in temperature of said temperature control device.

34. The method of claim 29, wherein said pre-selected remote device is a motion detector.

35. A computer-readable medium having computer-executable instructions for performing the method recited in any one of claims 29-34.

36. A computer system having a processor, a memory, and an operating environment, said computer system operable to perform the method recited in any one of claims 29-34.

37. A system for dynamically generating a user interface for controlling at least one remote device comprising:
at least one remote device operable to receive control commands and to transmit monitoring data based on said control commands;
a server computer in communication with said remote device, said server computer operable to dynamically generate a graphical user interface based on said remote device;
a client computer in communication with said premises server, said client computer operable to display said graphical user interface, and request said control commands.

38. The system of claim 37, further comprising a proxy server in communication with said client computer and said premises server, said proxy server operable to process and store monitoring data generated by said remote device.

39. The system of claim 37, wherein said server computer and said client computer are in communication via the Internet.

40. The system of claim 37, wherein said server computer and said client computer are in communication via a dedicated device control network.
